(19) United States
(12) Patent Application Publication
(10) Pub. No.: US 2001/0039521 A1
(43) Pub. Date: Nov. 8, 2001

(54) Budget information and analysis system and method

(76) Inventors: Anna J. Mattson, St. George Island, FL (US); Sherri R. Taylor, Tallahassee, FL (US)

Correspondence Address: Allen,Dyer, Doppelt, Milbrath & Gilchrist, P.A., Suite 1401, 255 South Orange Avenue, P.O. Box 3791, Orlando, FL, 32802-3791, US

(21) Appl. No.: 09/794,304

(22) Filed: Feb. 27, 2001

Related U.S. Application Data
(60) Provisional application No. 60/185,830, filed on Feb. 29, 2000.

(51) Int. Cl. G06F 17/60

(52) U.S. Cl. 705/30

(57) ABSTRACT

The budget information system includes a budgetary information database having numerical data and associated textual identifiers. Searching on the database permits receiving correlated budget data on a desired topic. The system is built by accessing a database containing raw budget data and textual information on a plurality of budgetary subdivisions. A list of titles of at least some of the budgetary subdivisions is compiled, and a first computer screen containing the list of titles is created. A numerical record on a selected budget subdivision is retrieved into a spreadsheet application, and a textual record on the selected budget subdivision is retrieved into a word processing application. A second screen is then formatted that contains the numerical record and the textual record in tabular form, and a link is provided between a title of the subdivision on the first screen with the second screen.

### CROSS-REFERENCE TO RELATED APPLICATION

This application claims priority from provisional application Ser. No. 60/185,830, filed Feb. 29, 2000, entitled “Querying Method to Budget Information Network via Internet Access.” The disclosure of that application is hereby incorporated by reference into the present application.

### BACKGROUND OF THE INVENTION

1. Field of the Invention

The present invention relates to systems and methods for accessing budgetary information and, more particularly, to such systems and methods for accessing governmental budgetary information via a network.

2. Description of Related Art

Governmental budget systems, such as that known in the art in Florida, are often housed on mainframes, with program files being difficult to access and manipulate, especially for a person not conversant with complex computer coding. To properly use and understand such applications typically requires extensive training and a background in the budget desired to be accessed. For elected officials, a staff is required to mine data as desired; for a person outside the government, it would be virtually impossible to obtain such data in a desired form.

In the exemplary Florida system, operational systems data for state personnel, accounting, budgeting, and planning are housed in separate mainframe computers that are not linked and are incompatible. Reengineering such a system would present a difficult, time-consuming, and expensive challenge.

### SUMMARY OF THE INVENTION

It is therefore an object of the present invention to provide a system and method for accessing budgetary data via a network.

It is a further object to provide such a system and method that is indexed under a plurality of categories.

It is another object to provide such a system and method that is accessible via the Internet.

It is an additional object to provide such a system and method that contains links to related electronic sites for correlating budget information with other data.

It is yet a further object to provide such a system and method that is tailored for governmental budgetary data.

It is yet another object to provide such a system and method that can perform zero-based budget analysis.

These and other objects are achieved by the present invention, a budget information system that comprises a budgetary information database that includes numerical data and textual identifiers imported from a remote site. The numerical data are extracted from the remote site into a spreadsheet or similar application, and the textual identifiers are extracted from the remote site into a word processing application. The system also comprises means for receiving a keyword selected by a user and means for matching the database with the keyword. The keyword “selection” may comprise, for example, the user's entering the keyword into a search engine; alternatively, the selection may comprise clicking an item on the screen with a pointing device, that item linked to related data in the database. Means for formatting and outputting related budget data and a textual identifier that were found from the database search commensurate with the keyword match permit the user to receive correlated budget data on a desired topic.

Another aspect of the present invention are methods for building, accessing, and using a budget information system. This method comprises the steps of accessing a database containing raw budget data and textual information on a plurality of budgetary subdivisions. Next a list of titles of at least some of the budgetary subdivisions is compiled, and a first computer screen containing the list of titles is created.

In use, a numerical record on a selected budget subdivision is retrieved into a spreadsheet application, and a textual record on the selected budget subdivision is retrieved into a word processing application. A second screen is then formatted that contains the numerical record and the textual record in tabular form, and a link is provided between a title of the subdivision on the first screen with the second screen.

A multiplicity of features is provided by the present system and method, including, but not intended to be limited to:

the ability to review data imported from disparate planning, budget, accounting, and personnel sources across subdivisions/agencies in order to effectively manage resources;

the ability to access the data via a network, such as the Internet, from any location and any time;

the integration of sources of operational data;

a searchable data system;

the ability to track items of interest for review, including business processes that are deemed to be of high or low priority, the budget needed to support that process, the positions necessary, and the expense related to that process;

the ability to review business processes

the ability to “drill down” (expand) expense category details; and

the ability to review employee position data in context of the planning documents, such as support of a particular process, salary information, work location, etc.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIGS. 1A,1B is a flowchart of the method for creating the information system of the present invention.

FIG. 2 is a schematic diagram showing a functional analysis of spending data.

FIG. 3 is a home page screen for the system accessed via the Internet.

FIG. 4 is a decision chart of information screens accessible by the system.

FIG. 5 is an exemplary contact data screen.

FIG. 6 is a flow chart of the method for entering the system for accessing budgetary data using the system of the present invention.

FIG. 7 is a screen tabulating budget issues for the current fiscal year.

FIG. 8 is a screen tabulating budget issues with one issue further divided for the current fiscal year.

FIG. 9 is a screen tabulating line item divisions for a selected issue.

FIG. 10 is a screen tabulating budget detail information and presenting issue narrative justification.

FIG. 11 is a screen expanding on budget details for a selected item.

FIG. 12 is a screen giving agency budget details.

FIG. 13 is a screen giving search results.

FIG. 14 is a screen listing budget bills.

FIG. 15 is a screen showing section titles of a selected bill.

FIG. 16 is a screen expanding on a selected section to give items and associated verbiage.

FIG. 17 is a screen giving details of a specific selected appropriation.

FIG. 18 is a screen giving results of a search on budget bills.

FIG. 19 is a screen giving details of an appropriation.

FIG. 20 is a screen for selecting items to be tracked.

FIG. 21 is a screen containing details of a tracked folder.

FIG. 22 is a screen containing personalized comments and textual information on a tracked item.

FIG. 23 is a list of reference materials available on the system.

### DETAILED DESCRIPTION OF THE PREFERRED EMBODIMENTS

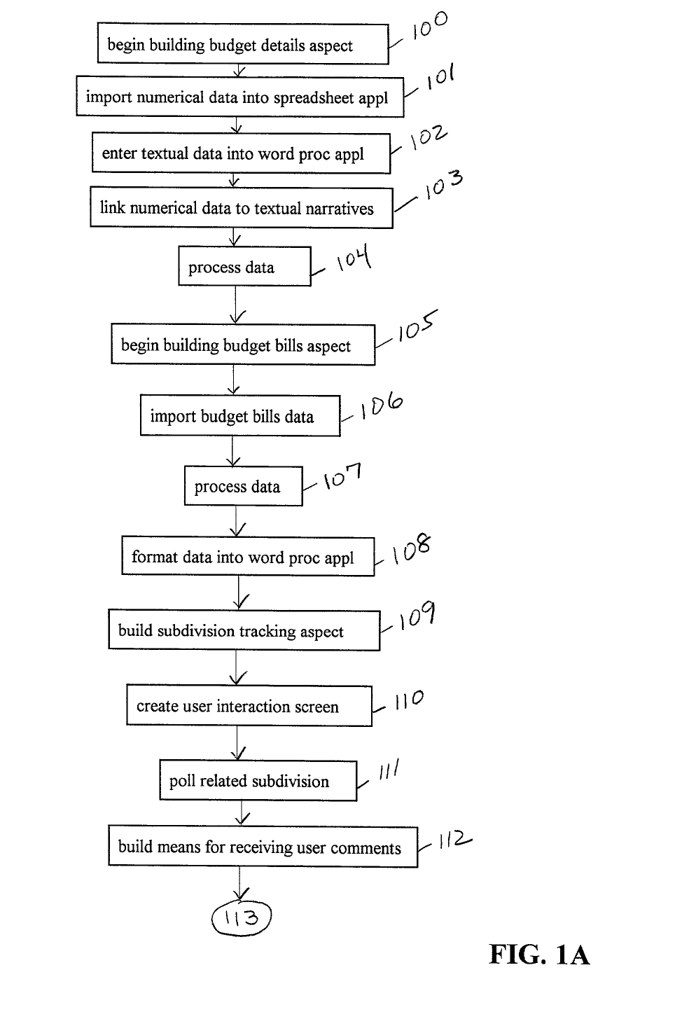

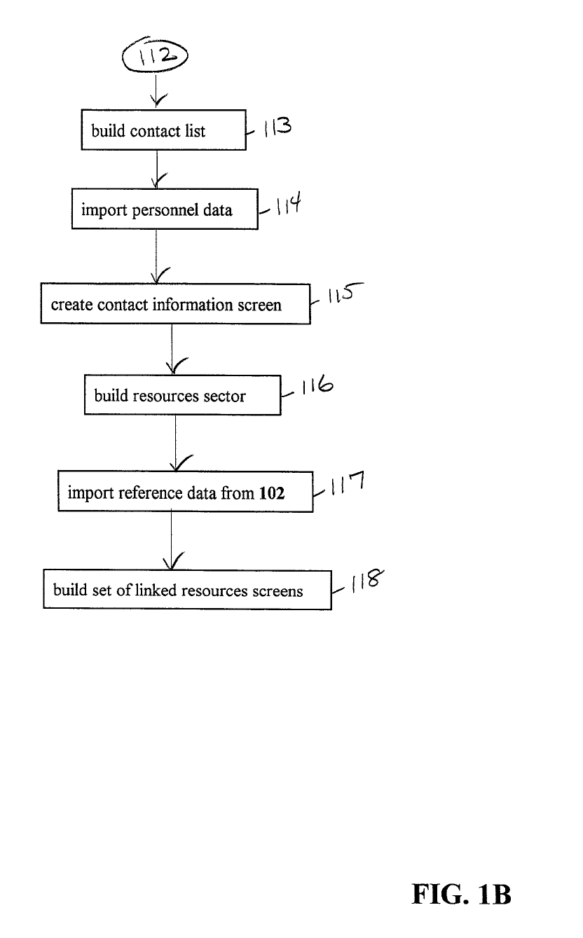

A description of the preferred embodiments of the present invention will now be presented with reference to FIGS. 1A-24. The particular embodiment disclosed herein is directed to an interactive budget information system for state or other governmental budgetary data, here Florida. It will be understood by one of skill in the art, however, that the system is adaptable to any budgetary information desired for presentation to a remote user, such as corporate or other institutional budget and financial data. Therefore, the generic term subdivisions used herein refers in the specific governmental case to agencies or departments; likewise, the subdivisions are broken down into line items, which refers to issues, which themselves are typically broken down further into individual expenditures.

Creation of Budget Information System

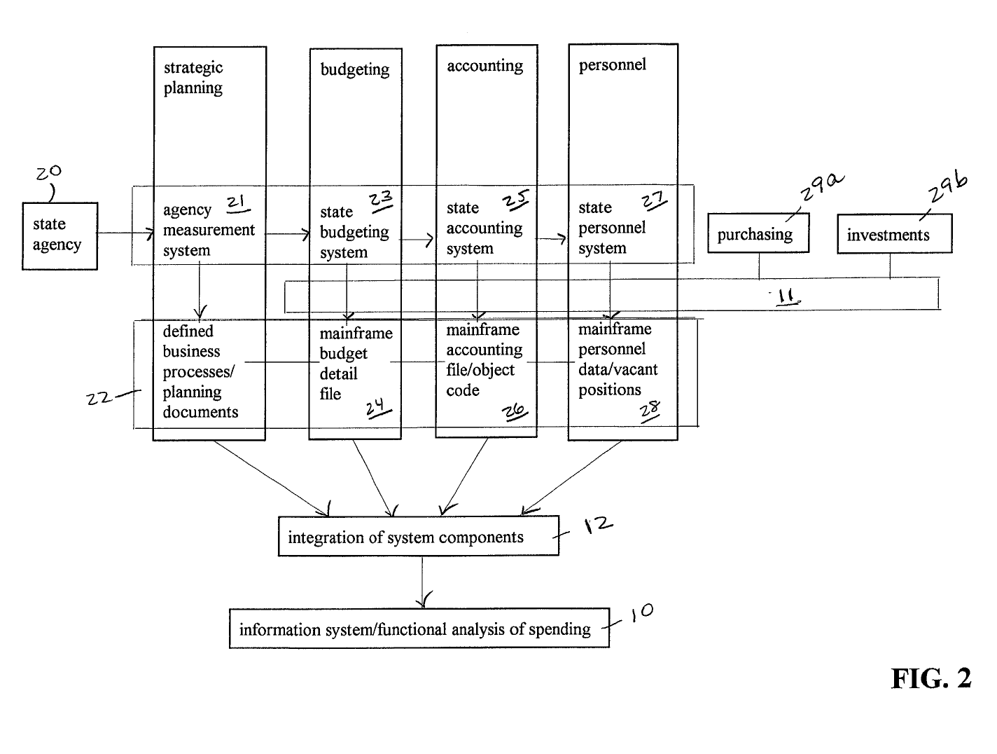

The method for building the budget details aspect of the system 10 of the present invention (block 100) is illustrated in flowchart form in FIGS. 1A, 1 B, and the functional flow of agency data used to supply the system 10 is shown in FIG. 2. In the particular embodiment illustrated here, the budget data are imported from a mainframe computer located at a central site, such as a state capital. In the specific case of Florida, such data files are received from the Office of the Governor, Office of Systems Design and Development. A new document is created in the system site to which the imported data files are attached. This step comprises importing numerical data into a spreadsheet application, such as, but not intended to be limited to, Excel or Lotus software (block 101), creating a budget detail database and excluding portions of the files not desired for inclusion in this database, such as Bill data. The next step comprises importing the textual data into a word processing application, such as, but not intended to be limited to, Lotus Notes or Lotus Script (block 102). The numerical data are linked to the textual narratives (block 103), as will be discussed in the following. These data are imported into a system site computer, where all further processing (block 104) takes place. Some form of data massaging may be required, as will be understood by one of skill in the art, depending upon the form in which they are supplied, such as uncompressing or removing record delimiters.

In the current embodiment, the system 10 integrates data from a plurality of mainframe computers, each housing disparate systems, and creates a web-enabled information site. Such an integration of information will enable users to review planning, budget, accounting, personnel, purchasing, and investment data across agencies in order to effectively manage resources. Referring to FIG. 2, it can be seen the budget data flow from, for example, a state agency 20, which provides data for the agency measurement system 21. This system 21 contains defined business processes and planning documents 22. The agency measurement system 21 provides data for the state budgeting system 23, which contains mainframe budget detail files 24. The state budgeting system 23 provides data for the state accounting system 25, which contains the mainframe accounting file object codes 26. The state accounting system 25 provides data for the state personnel system 27, which contains mainframe personnel data and information on vacant positions 28. Purchasing data 29a and Investment data 29b feed, along with budgeting 23, accounting 25, and personnel 27 systems feed into an integrated financial management system 11. The system components 22,24,26,28 are further integrated 12 by the system 10 and serve as sources for the system 10. Steps 101,102 are repeated each time a new iteration of the state budget is released, from an original agency request, through a legislative session with each version of the budget from the House and the Senate, and the Governor's office, to the final appropriations and the Governor's vetoed items. Thus FIG. 2 serves as a template indicating the structure of a zero-based budget reviewing system, permitting data integration, search capabilities, and data mining and reporting, as will be detailed in the following.

The system 10 also incorporates the building of a plurality of linked screens that will use all the budgetary numerical and textual data housed in the local computer. These screens, which will be detailed in the following section, include a “home,” or entry, page comprising a sign in feature (name, password, etc.). Linked to the home page are a plurality of system sectors accessed by selecting from a plurality of tabs.

The system 10 also permits a user to access information on budget bills (block 105) as above for the budget data. This aspect of the system 10 is created by importing data from the mainframe computer at the central site (block 106), copying the data into a file, massaging the data as needed (block 107), copying the data into the database created during the creation of the Budget Details, preparing the table titles from the word processing file, and formatting the information into the word processing program (block 108).

A further feature of the system 10 comprises the ability to track subdivisions of the budget database (block 109). This feature is built by using a software application that has been written to establish tracking records in a created tracking database for each item tracked. This record is unique to the user creating the tracking record and has a unique folder name associated therewith. If the tracking record already exists, it is updated with the latest budget data. The tracking record is linked to the original budget item by a unique ID number. When the tracking record, which is editable for the user, is opened, the original budget item document is retrieved and displayed within the same document, which enables the tracking item to appear as the user's private version of the original document, with the user's comments associated to the budget item. The user interface screen, which is adapted to receive user a selection (block 110), triggers a polling of the subdivision related to that selection (block 111) to update the data each time the user accesses the system 10. The user comments (block 112) remain with the folder item.

Another feature of the system 10 comprises the presentation of a list of contacts (block 113) associated with each subdivision/agency. This element is built by pulling personnel data imported at step 102 into a file (block 114) and creating a screen listing name and contact information (block 115).

A resources sector is created (block 116) to include reference information, with data included from the importation of data at step 102 and other explanatory material (block 117) to assist a user in navigating the state government system, which may have been created from other sources as well as the central site database to build a set of linked resources screens (block 118).

Accessing and Using the Budget Information System

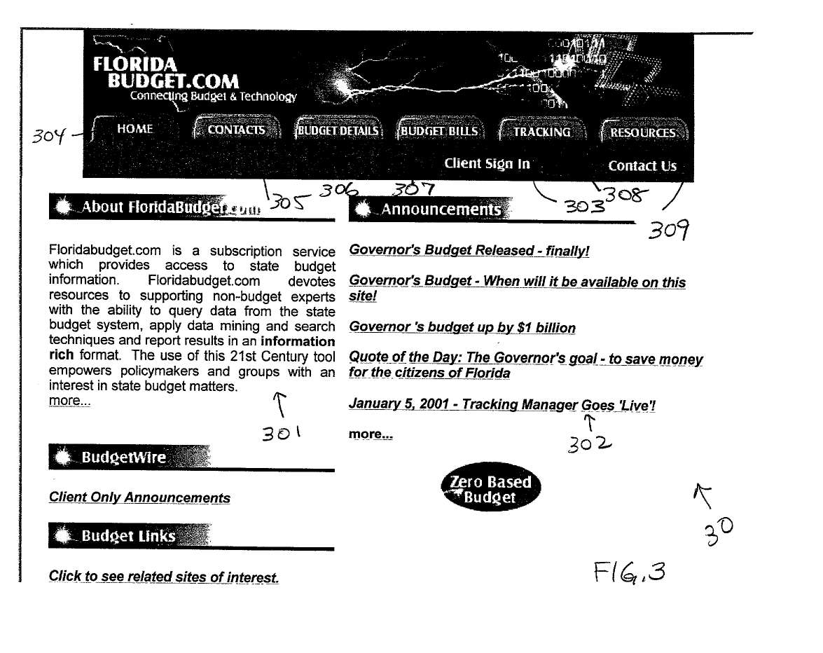

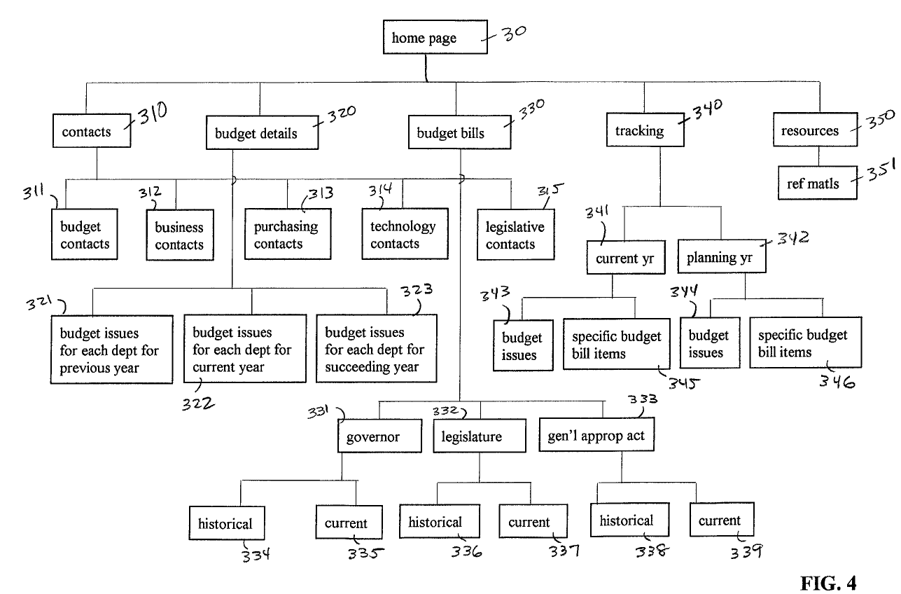

In the exemplary embodiment presented herein, a user desiring budgetary information enters the system 10 via a network, such as the Internet, by entering a web site hosting the system 10. A home page screen 30 (FIG. 3) appears, with a description of the site 301 and various electronic links (“hot” links) to, among other things, announcements 302. In order to view the data, the user in this embodiment must sign in 303, although this is not intended as a limitation. A plurality of tabs 304-309 at the top of the screen 30 provide access to the identified sectors of the system 10, the decision hierarchy for which is shown in FIG. 4.

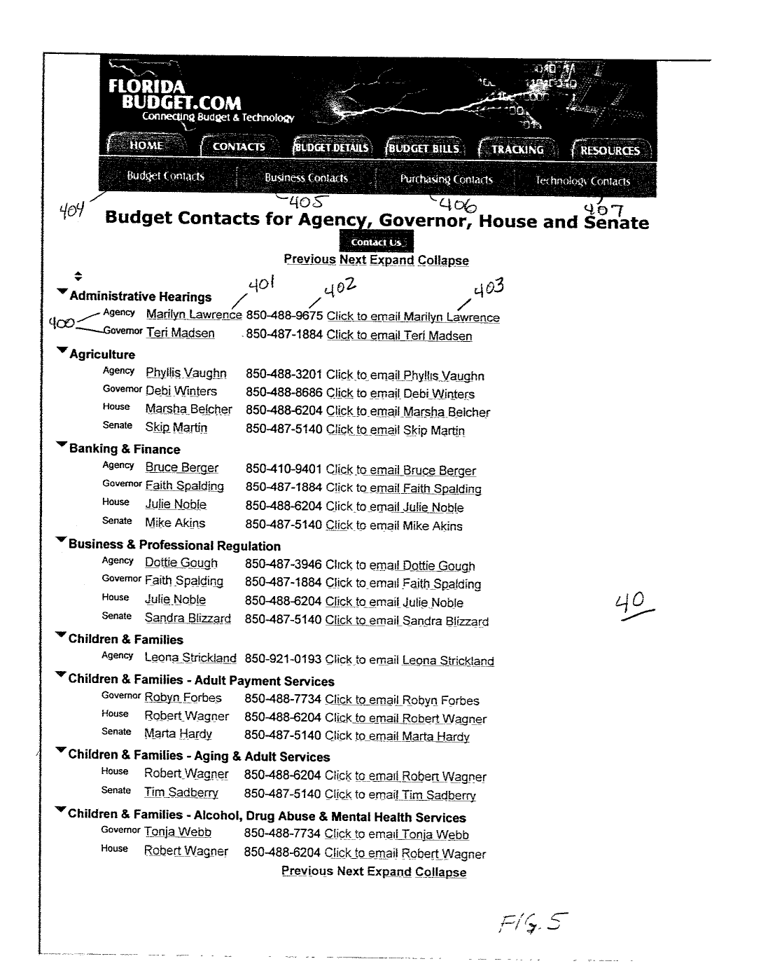

If the user selects the “contacts” tab 305, block 310 on FIG. 4, a screen 41 appears (FIG. 5) that lists budget contacts broken down into subdivisions/agencies. Each agency listing includes contact people reporting to one or more parts of the government 400, by name 401, telephone number 402, and hot link to email 403. Also belonging to the contact sector are screens (not shown) for budget contacts 311, business contacts 312, purchasing contacts 313, technology contacts 314, and legislative contacts 315 accessible by subtabs 404-407.

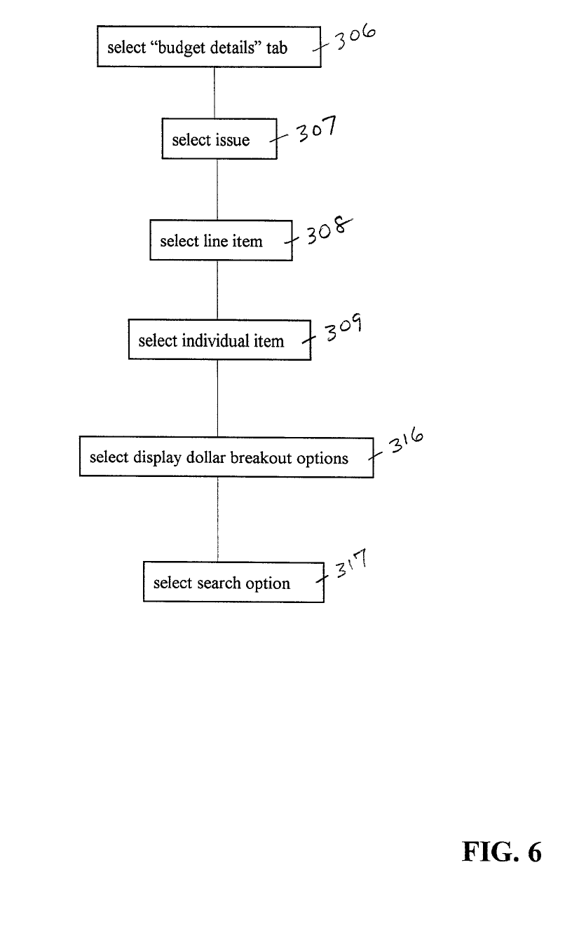

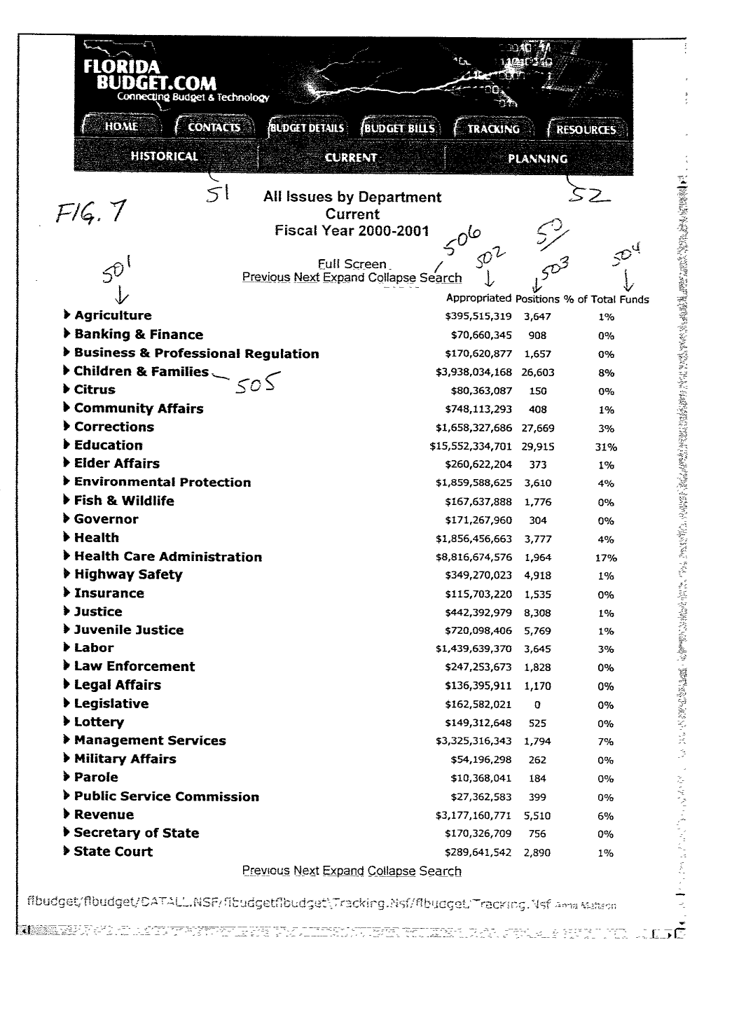

The method for viewing details of a budget is illustrated in flowchart form in FIG. 6. If the user selects the “budget details” tab 306, block 320 on FIG. 4, block 201 on FIG. 6, a screen 50 appears (FIG. 7) that lists all state budget issues 501 alphabetically for the current fiscal year. Tabulated on this screen 50 (block 322, FIG. 4) are data for appropriated spending 502, number of positions allocated 503, and the percentage of total budgeted funds 504. Similar screens are available for historical data 321 and planned future data 323.

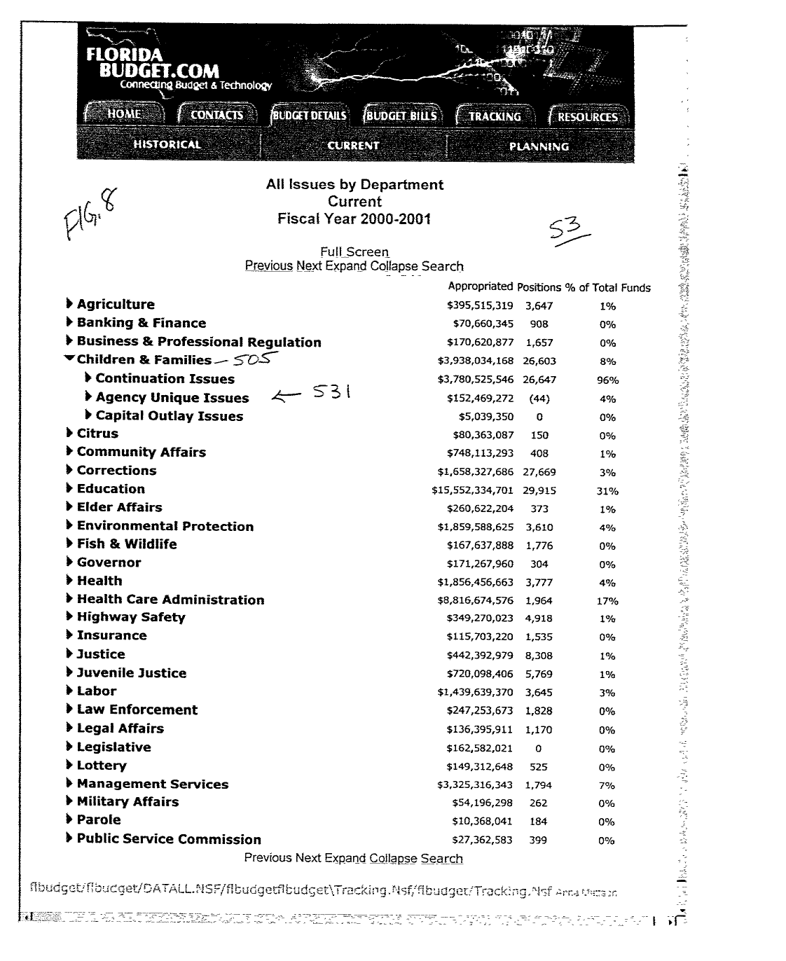

An additional feature of this sector of the system 10 is the ability to “drill down” each budget issue 501 and display further divisions, or line items, under a selected budget issue 501. This is accomplished by selecting one of the issues (block 307, FIG. 6), which brings up screen 53 (FIG. 8), selected by selecting “Children & Families” 505 on FIG. 7. Here finer divisions 531 are broken out, in similar tabular form to FIG. 7.

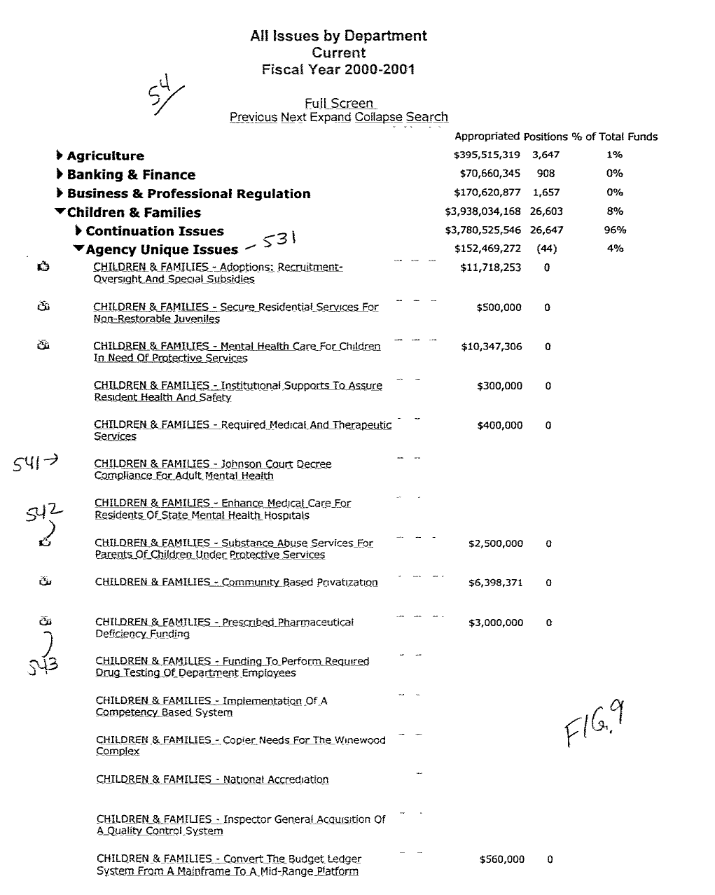

Yet more information is available by selecting one of the line items 531, here “Agency Unique Issues,” to bring up individual budget items 541 on screen 54 (FIG. 9, block 308 on FIG. 6), tabulated as before. Also indicated on this screen 54 to the left of the items 531 is how the funding on each item 531 arose, with icons indicating that the appropriation was agreed upon 542 or compromised upon 543.

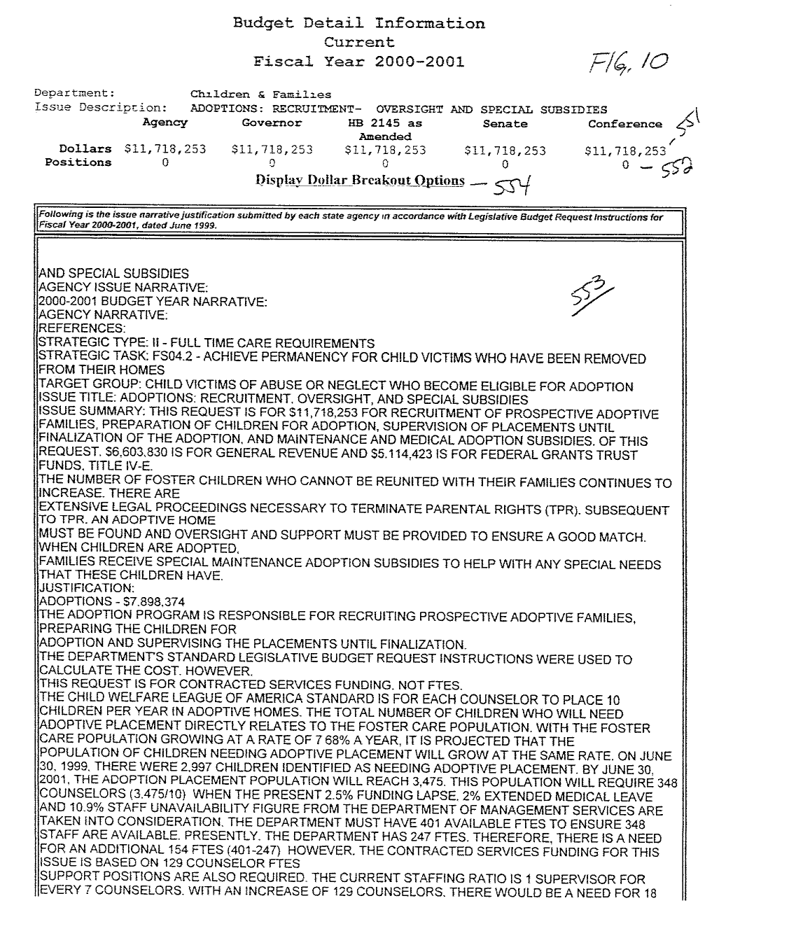

Selecting one of the individual items 541 (block 309, FIG. 6) brings up a budget detail information screen 55 (FIG. 10). This screen 55 gives budgets 551 as proposed by various government sectors and the number of positions 552 proposed. Additionally, an issue narrative 553 that had been submitted by each state agency is presented.

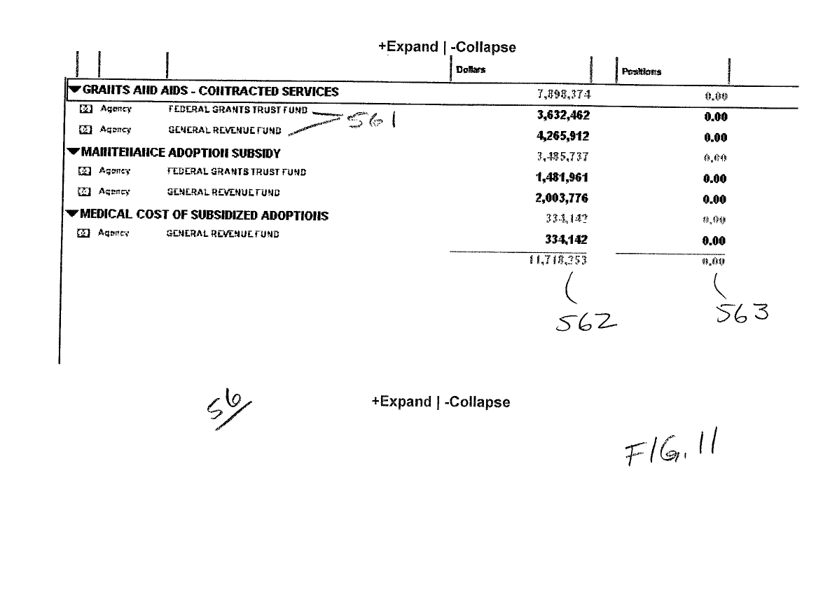

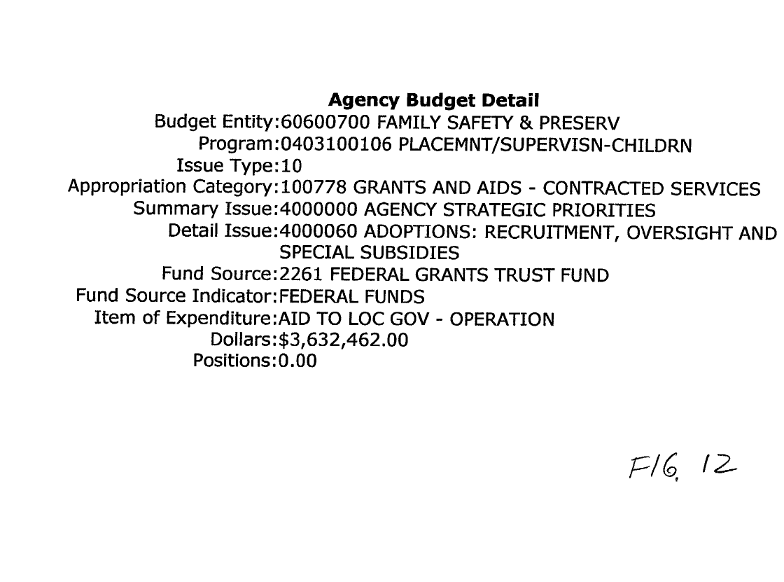

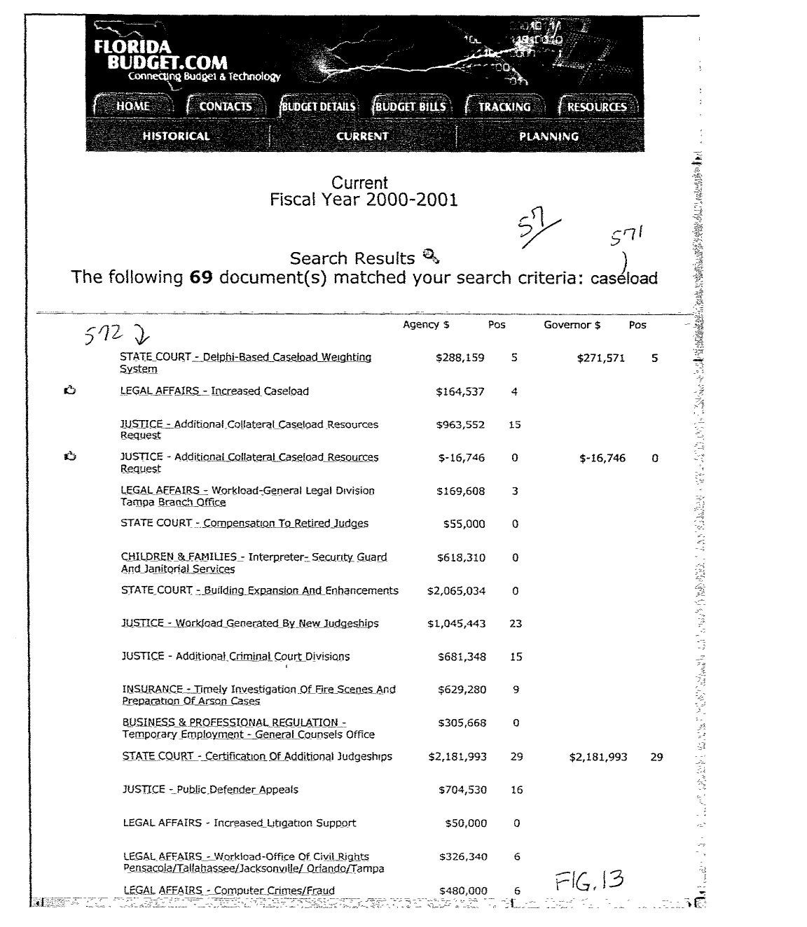

Selecting the “Display Dollar Breakout Options” link 554 (block 316, FIG. 6) brings up a screen 56 (FIG. 11) indicating the funding sources 561, budgeted amount 562, and positions 563 for each breakdown. Yet further detail is available by selecting one of these sources 561 to bring up screen 57 (FIG. 12) to view agency budget details. Additional details may be accessed by drilling down into specific expense categories, selected by budgeting, accounting, accounting details, or personnel.

Thus, using the present system 10, detailed budget information can be accessed and reviewed for the current year, including agency budget request, governor's recommendations, legislative proposals, and a final conference committee report (i.e., a general appropriations act for the fiscal year). Access is also available for next year's budget preparation, beginning with the agency budget request, governor's recommendations, legislative proposals, and final conference committee report. Searches can be performed on a word or group of words and can have results reported by continuation base, agency initiatives, and capital outlay projects.

In addition to “drilling down” by selecting links on any of the available screens, it is also possible in the present system 10 to search by a keyword, by selecting the “Search” option 506 of any of screens 50,53,54 (block 317, FIG. 6). In the example screen 57 illustrated in FIG. 13, a search has been performed on the word caseload 571, with a list of linked items 572 tabulated as previously.

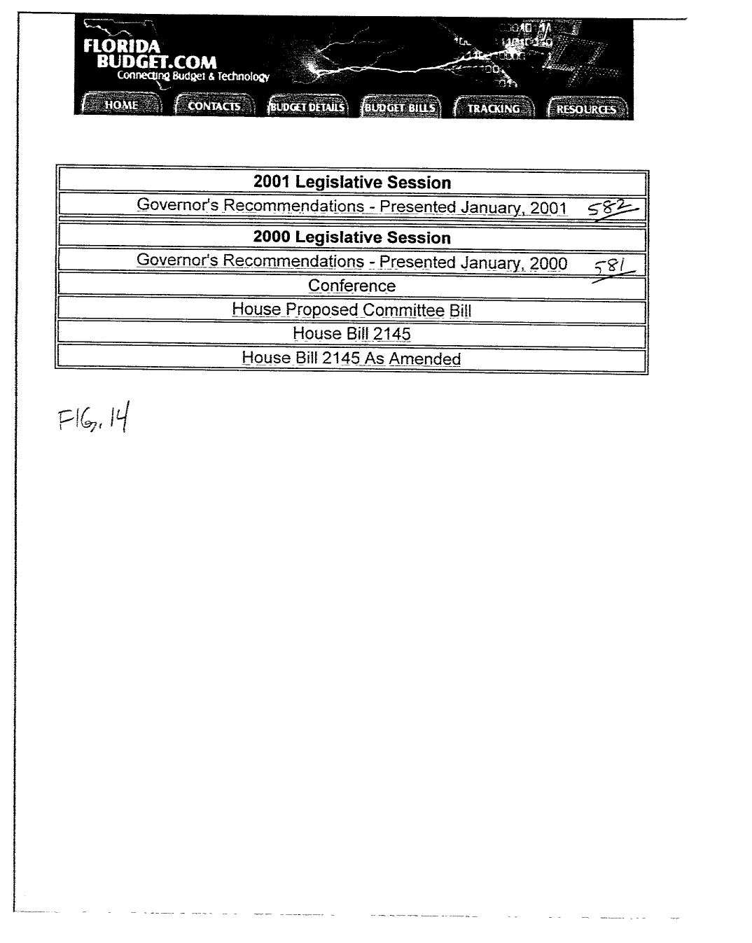

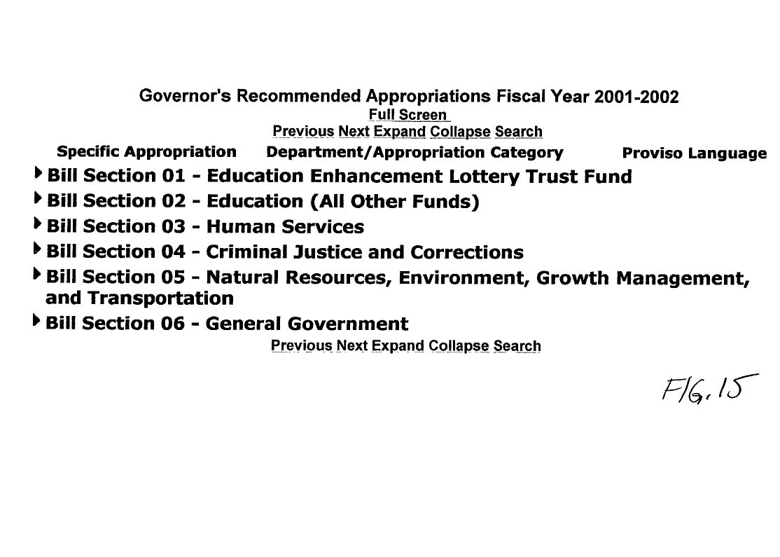

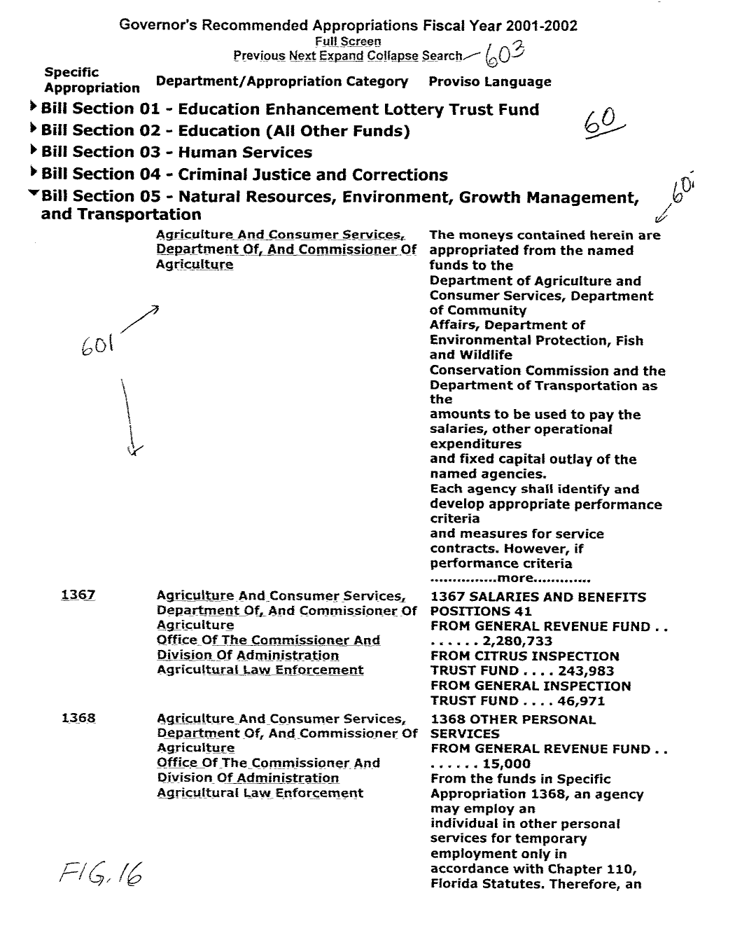

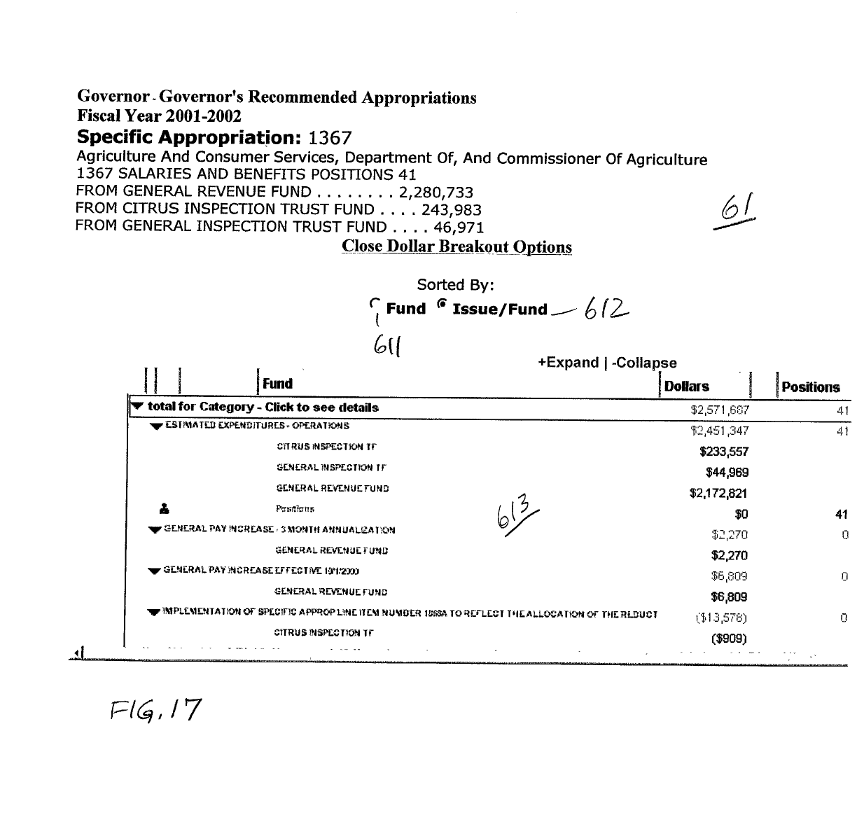

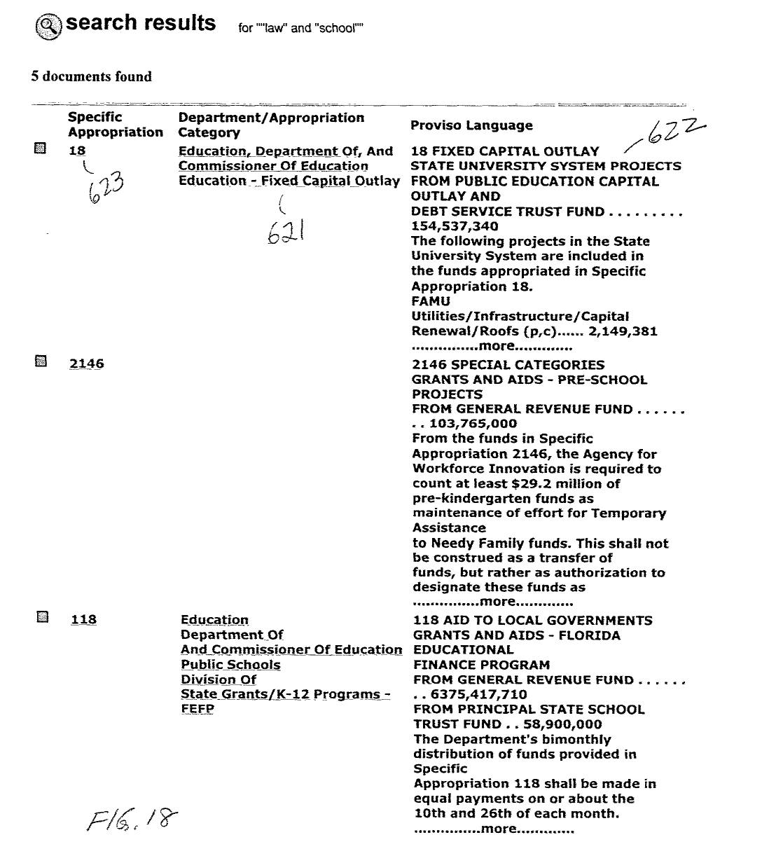

The next sector of the system, budget bills 32, is accessed by selecting tab 306, which brings up a summary of budget bills on screen 58 (FIG. 14; blocks 330-339). This screen 58 contains bills for current 581 and next 582 fiscal years, each listed item linked to further data. Selecting the current session's governor's recommendations, for example, brings up screen 59 (FIG. 15), which lists bill sections 591. Each of these, in turn, is linked to a screen 60 (FIG. 16) that provides further details by agency 601, including appropriations details 602. These details 601 are again linked to an appropriation screen 61 (FIG. 17) containing information 613 sortable by fund 611 or issue/fund 612.

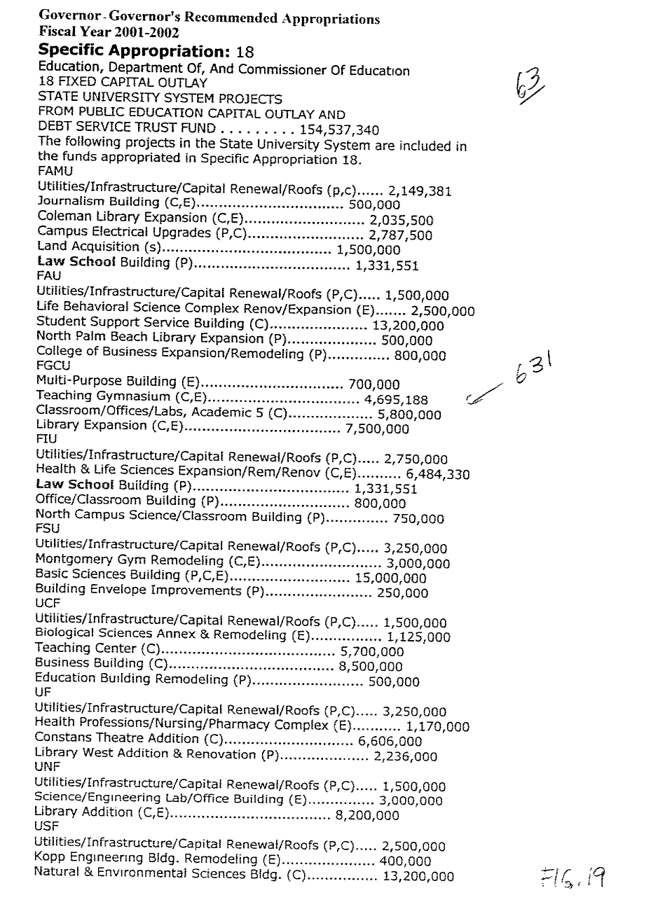

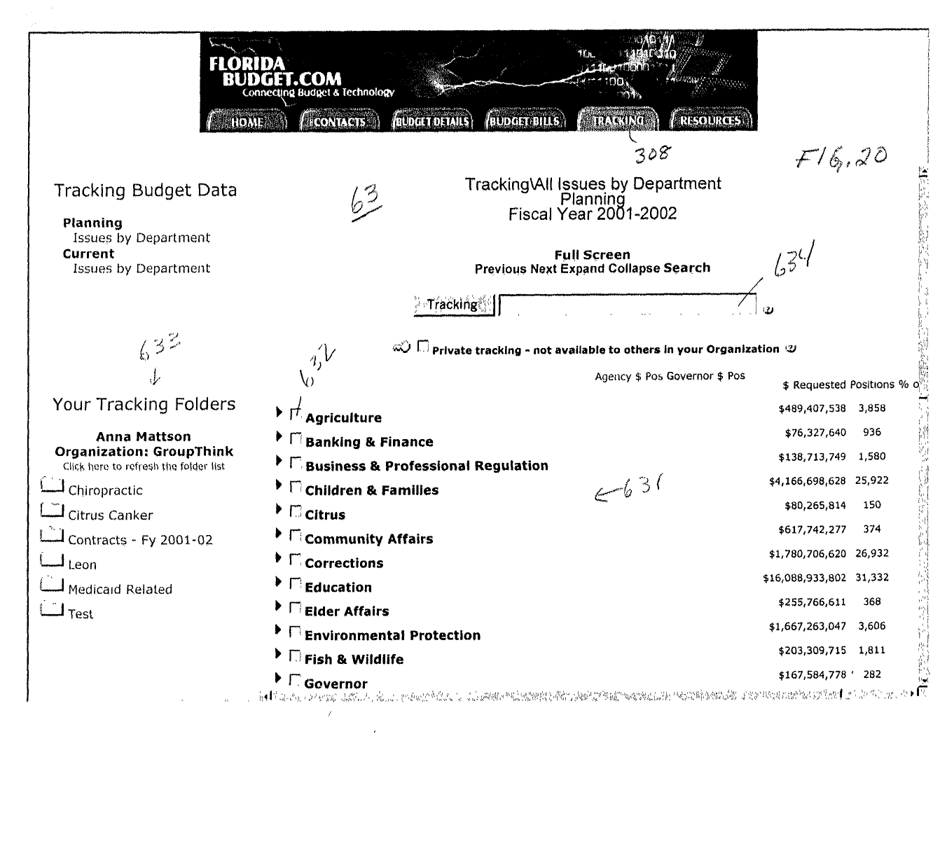

Searches are also available by selecting the “Search” option 603 on screen 60 (FIG. 16), the results of which appear as on screen 62 (FIG. 18) for the words law and screen. Each of the listed items 621 tabulated under “Department/Appropriation Category” also has bill language 622 included and an appropriation number 623 for each. If one of these is selected, screen 63 (FIG. 19) appears, giving appropriations details 631.

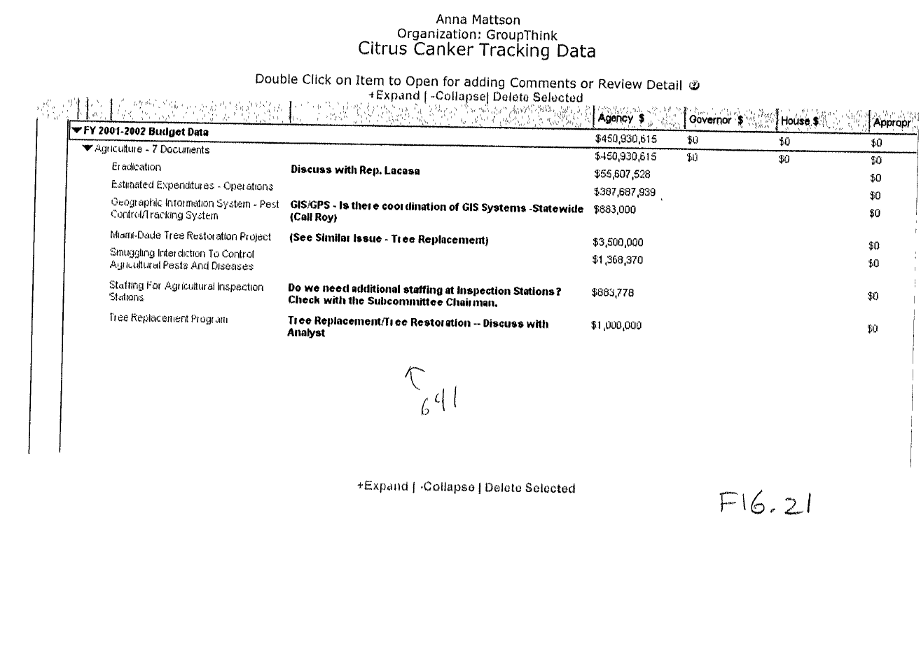

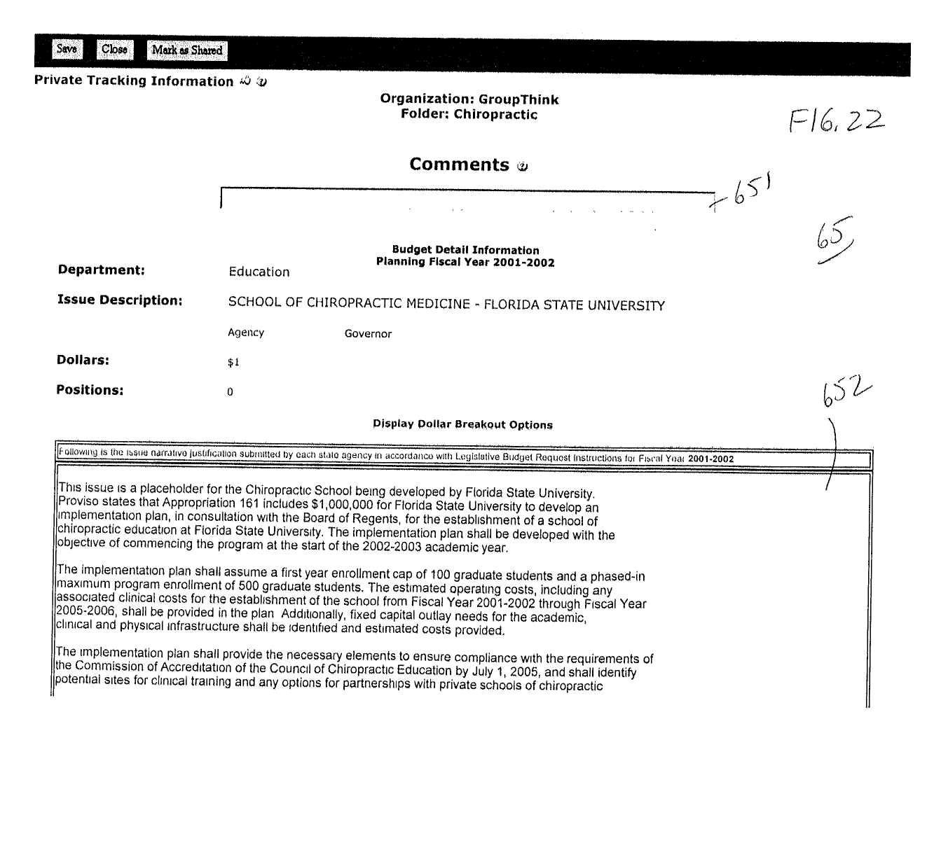

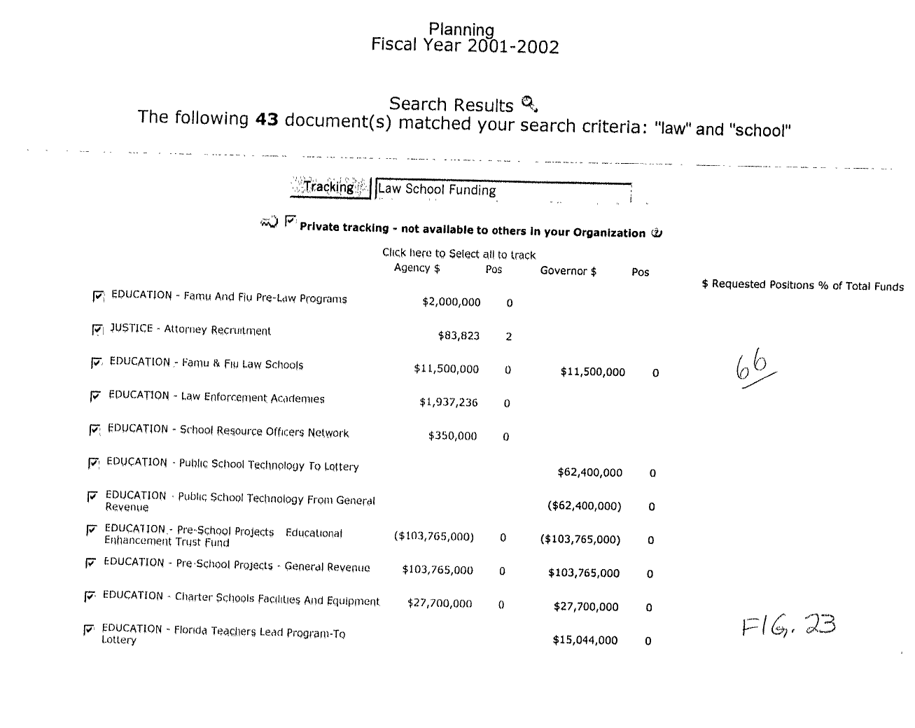

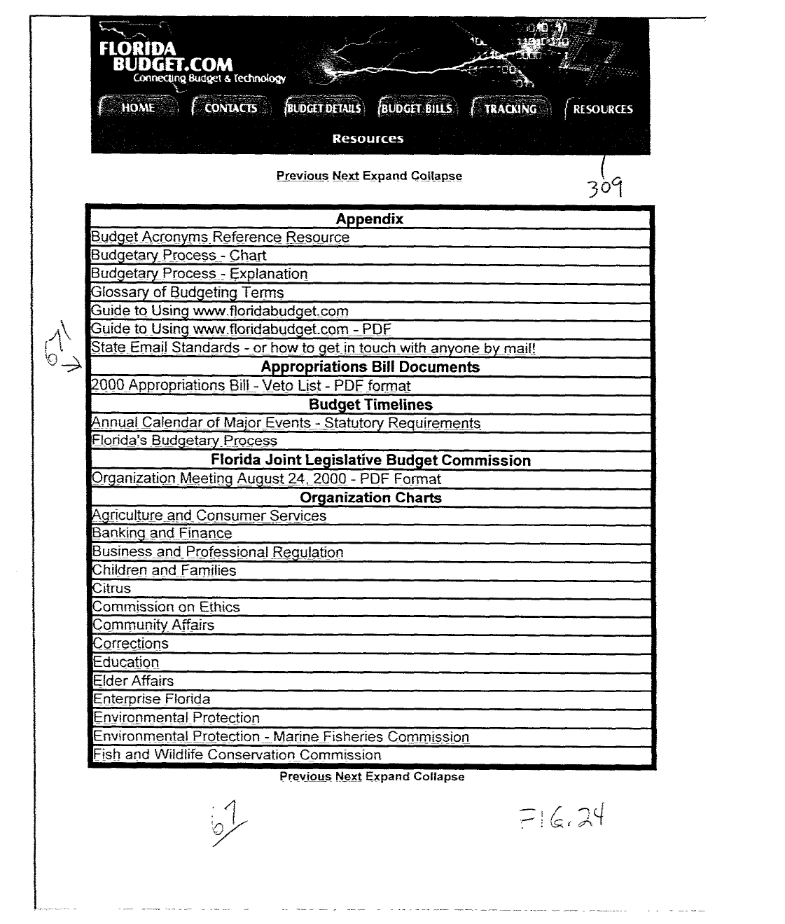

If the user selects the “tracking” tab 308, a budget data tracking screen 63 (FIG. 20; block 340, FIG. 4) that permits the user to customize one or more of the subdivisions 631 to follow over the current fiscal year 341 or planning fiscal year 342 by updating any changes that occur in budget issues 343,344 or specific budget bill items 345,346 over time. Selecting a subdivision 631 places a checkmark in the associated box 632 and permits that item to be added to the tracking folder 633. If an item 631 is selected, screen 64 (FIG. 21) is brought up, including details 641 of the tracked folder. Selecting one of the tracked items 632, which appear in the user's folder 633, brings up screen 65 (FIG. 22), on which personalized comments can be made 651 to be retained with the user's folder and on which textual information 652 appears regarding the budget item. If a word or phrase is entered into box 634, screen 66 (FIG. 23) appears, wherein the search results are presented, along with links to the items' budget data.

If the user selects the “resources” tab 309 (block 350, FIG. 4), access may be gained to reference materials (block 351, FIG. 4) as listed on screen 67 (FIG. 24). The elements 671 of this list are all linked to information on subsequent screens, which include organizational charts, glossaries of terms, and user guide information. This list is not intended as a limitation, and other elements may be conceived by one of skill in the art.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiment thereof, and the advantageous new and useful results obtained thereby, the new and useful constructions, and reasonable mechanical equivalents thereof obvious to those skilled in the art, are set forth in the appended claims.

What is claimed is:

1. A budget information system comprising:
a budgetary information database comprising numerical data and textual identifiers imported from a remote site, the numerical data extracted from the remote site into a spreadsheet application, the textual identifiers extracted from the remote site into a word processing application;
means for receiving a keyword selected by a user;
means for matching data in the database with the keyword; and
means for formatting and outputting matched budget data and a textual identifier found from the database search commensurate with the keyword match.

2. The budget information system recited in claim 1, wherein the database is in electronic communication with a network and the accessing means comprises means for accessing the network.

3. The budget information system recited in claim 1, wherein the system further comprises software installable on a processor, the software adapted to output a list of database subdivisions, the keyword selectable from the list of subdivisions, and to perform the database search.

4. The budget information system recited in claim 3, wherein the database subdivisions comprise government agencies and the budget data comprise fiscal year budgeted amounts.

5. The budget information system recited in claim 4, wherein a first database subdivision comprises a plurality of line items, each line item having a separate budget, the sum of the line items equaling a total budget for the first database subdivision.

6. The budget information system recited in claim 3, wherein the software comprises:
means for importing the output budget data into a spreadsheet application;
means for importing text material related to the output budget data into a word processing program; and
means for correlating the text material and the output budget data for presentation on a unitary screen.

7. The budget information system recited in claim 6, wherein the output budget data are selected from a group consisting of previous time period data, current time period data, and proposed future time period data.

8. The budget information system recited in claim 6, wherein the software further comprises means for calculating and presenting a percentage of a total budget appropriated for each subdivision.

9. The budget information system recited in claim 6, wherein the software further comprises means for importing with the budget data a number of personnel positions associated with each subdivision.

10. The budget information system recited in claim 6, wherein the software further comprises means for importing with the budget data a contact agent associated with each subdivision, and for presenting a name of the contact agent and contact information for the contact agent.

11. The budget information system recited in claim 10, wherein the presented contact information comprises a direct contact electronic linkage therewith.

12. A method for accessing and searching a remote budget database for data in a desired category, the method comprising the steps of:
entering an electronic user site, the user site adapted to present a list of budgetary subdivisions;
electronically selecting one of the subdivisions, each subdivision electronically linked to budget data therefor;
viewing the subdivision budget data, the budget data selected from a group consisting of previous time period data, current time period data, and proposed future time period data;
if desired, selecting an option to view more detailed data on the subdivision budget data; and
if desired, selecting an option to view additional information on the subdivision in textual form.

13. The method recited in claim 12, wherein the subdivision data comprise budget data as proposed by a plurality of entities.

14. The method recited in claim 12, wherein the additional information in textual form comprises spending authorization information and justification for funding.

15. The method recited in claim 12, wherein the budget database comprises governmental funding data and the subdivisions comprise government agencies.

16. The method recited in claim 12, further comprising the steps, following with subdivision budget data viewing step, of:
viewing a breakdown of the selected subdivision budget data into line items;
electronically selecting a desired line item; and
viewing the line item budget data.

17. A method for building a budget information system comprising the steps of:
accessing a database containing raw budget data and textual information on a plurality of budgetary subdivisions;
compiling a list of titles of at least some of the budgetary subdivisions;
creating a first computer screen containing the list of titles;
retrieving a numerical record on a selected budget subdivision into a spreadsheet application;
retrieving a textual record on the selected budget subdivision into a word processing application;
formatting a second screen containing the numerical record and the textual record in tabular form;
providing a link between a title of the subdivision on the first screen with the second screen.
